(19) United States
(12) Patent Application Publication
(10) Pub. No.: US 2010/0141403 A1
(43) Pub. Date: Jun. 10, 2010

(54) DEVICES AND METHODS USEFUL FOR AUTHORIZING PURCHASES ASSOCIATED WITH A VEHICLE

(75) Inventors: Shimon Weitzhandler, RaAnana (IL); Yoav Vilnai, Tel-Aviv (IL)

Correspondence Address: MARTIN D. MOYNIHAN d/b/a PRTSI, INC., P.O. BOX 16446, ARLINGTON, VA, 22215, US

(73) Assignee: Petratec International Ltd., Kfar-Saba (IL)

(21) Appl. No.: 12/524,189

(22) PCT Filed: Dec. 19, 2007
(86) PCT No.: PCT/IL07/01575

§ 371 Date: Feb. 16, 2010

Related U.S. Application Data
(60) Provisional application No. 60/897,235, filed on Jan. 25, 2007.

(51) Int. Cl. H04Q 5/22

(52) U.S. Cl. 340/10.42

(57) ABSTRACT

Disclosed are various devices useful as components of a system for authorizing purchases associated with a vehicle that are generally simple to install, operate and maintain and are generally resistant to abuse. Devices disclosed include an identification vehicle identification tag reader with a loop-shaped antenna.

The present application gains benefit of the filing date of U.S. patent application No. 60/897,235 filed 25 Jan. 2007 which is incorporated by reference as if fully set forth herein.

### FIELD AND BACKGROUND OF THE INVENTION

The present invention relates to the field of purchase authorization and, more particularly, to methods and devices useful for implementing methods of purchase authorization associated with a vehicle.

In the past a gas station was primarily a location to purchase fuel for a vehicle and occasionally to purchase comestibles and products associated with vehicular operation. Increasingly, gas stations are transforming into service stations, becoming one of the most important retail venues in industrialized society. The reasons for the increasing importance of service stations as retail venues as well as the nature of the purchases result from the relative advantages of service stations which are dictated by the primary purpose of service stations: efficiently providing fuel to vehicles.

To be successful as a gas station, a service station must generally be located on a heavily traveled road, cover a large area allowing high speed entrance and egress, many fuel-dispensing locations arranged for high-throughput refueling of many continuously arriving vehicles and must have an efficient method for paying for the fuel. Increasingly, people are found traveling on the road for extended periods of time, and consequently have less time to purchase items at local stores and even to make a special trip for the purpose of shopping, especially as shopping trips often include time wasted in search of parking and walking to and from the vehicle. People have less opportunity to become acquainted with local stores so little loyalty develops to a local store and may not even know where such a store is located. At the same time, the actual refueling process requires a relatively long time, time which must be utilized.

As a result of the above factors, persons refueling at a service station find themselves with a car safely parked at a fuel-dispensing location waiting while the fuel is dispensed during which purchases of various and sundry goods may be performed. Given the above situation, a service station operator finds it desirable to increase the attractiveness of an own service station relative to other service stations, to increase revenues from non-fuel purchases performed at the service station and to engender customer loyalty.

Due to the development of sophisticated control electronics and vehicle identification devices, gasoline service stations have evolved into complex electronic systems having point-of-sale (POS) devices able to accommodate various types of payment means. One preferred method for increasing the attractiveness of a service station is through the use of automated payment for fuel. A vehicle is equipped with an identification tag storing data relating to the vehicle identity. A tag-reader is associated with each individual fuel-dispensing location, for example with the fuel-dispensing nozzle, of the service station. When the fuel-dispensing nozzle is placed inside the refueling port of the vehicle, a tag-reader reads data from the identification tag and transmits the data to a central location that issues an authorization signal to dispense fuel if the payment method is valid. Not only are such methods efficient allowing fuel dispensing and payment to occur virtually automatically, but also such methods reduce the chance of fuel-theft and gas-station robbery.

The advent of advanced service station systems has produced a need for increased transaction efficiency, a need met, for example, by the development of fully automated authorization and purchasing systems. In fully automated authorization and purchasing systems, the purchase of goods or services at service stations does not require a payment activity, such as by the use of cash, a credit card, debit card or the like. Rather, a vehicle is provided with a communications device such as, for example, identification tag, which stores data associated with the vehicle such as, for example, credit account details. The communications device is configured to communicate with other components of the service station systems such as, for example, fuel dispensers and cash registers. In this manner, the identification device automatically transmits data associated with the customer or vehicle and the system automatically carries out the financial aspects of the transaction such as payment for the purchase of goods or services, without requiring any specific action by the customer or by the service station employee.

In the art, various methods, systems, and devices for increasing the automation of vehicle refueling are known. The Applicant has disclosed innovative devices and methods useful for refueling vehicles in the PCT Patent Applications published as WO2007/049273 and WO2007/049274. Additional background art includes devices and methods disclosed in U.S. patent application Ser. No. 09/911,570 published as US 2003/0025600; U.S. patent application Ser. No. 10/425,073 published as US 2004/0215575; U.S. patent application Ser. No. 10/298,160 published as US 2004/0095230; U.S. patent application Ser. No. 11/042,196 published as US 2005/0184155; U.S. Pat. No. 5,857,501; U.S. Pat. No. 6,648,032 and U.S. Pat. No. 6,900,719.

It would be highly desirable to have devices that are components of purchase authorizing systems that are superior to those known in the art.

### SUMMARY OF THE INVENTION

The present invention is of methods and devices, some embodiments of which address at least some of the shortcomings of the prior art in the field of authorizing purchases associated with vehicles

According to an aspect of some embodiments of the present invention there is provided a vehicle identification tag reader that, in some embodiments, is simple to install or retrofit and exceptionally safe and durable by sealing components within a casing. In some embodiments a vehicle identification tag reader is abuse resistant and/or simple to install or retrofit in existing service stations.

According to an aspect of some embodiments of the present invention there is provided vehicle identification tag reader, comprising: a) a casing configured for attachment to a fuel-dispensing nozzle; b) an identification tag reading transceiver sealed within the casing; and c) a power storage unit (e.g., a battery), in some embodiments rechargeable, for supplying energy to the transceiver, preferably but not necessarily also sealed within the casing. In some embodiments, the transceiver is embedded within the casing. In some embodiments, the transceiver is enclosed within a sealed chamber inside the casing. In some embodiments the casing is monolithic. In some embodiments, the chamber is seamless.

According to an aspect of some embodiments of the present invention there is also provided a vehicle identification tag reader that, in some embodiments, is exceptionally safe by including a photovoltaic cell to provide power for the associated tag reading transceiver. Thus, according to an aspect of some embodiments of the present invention there is also provided a vehicle identification tag reader, comprising: a) a casing configured for attachment to a fuel-dispensing nozzle; b) an identification tag reading transceiver associated with the casing; c) a rechargeable power storage unit for supplying energy to the transceiver; and d) a photovoltaic cell to convert light to electrical energy to recharge the power storage unit. In some embodiments, the photovoltaic cell is sealed within the casing. In some embodiments, the photovoltaic cell is held within the casing and at least part of the casing is substantially transparent so as to allow light to pass through the transparent part and interact with the photovoltaic cell.

According to an aspect of some embodiments of the present invention there is also provided a vehicle identification tag reader that, in some embodiments, is exceptionally safe by including a fuel-dispensing nozzle trigger powered electricity generator to provide power for the associated tag reading transceiver. Thus according to an aspect of some embodiments of the present invention there is also provided a vehicle identification tag reader, comprising: a) a casing configured for attachment to a fuel-dispensing nozzle; b) an identification tag reading transceiver associated with the casing; c) a rechargeable power storage unit for supplying energy to the transceiver; and d) a generator to convert mechanical energy from actuation of a trigger of the fuel-dispensing nozzle into electrical energy to recharge the power storage unit.

According to an aspect of some embodiments of the present invention there is also provided a vehicle identification tag reader that, in some embodiments, is exceptionally safe by including an electricity generator that converts motion of the fuel-dispensing nozzle, e.g., shaking, jostling and the like, to provide power for the associated tag reading transceiver. Thus, according to an aspect of some embodiments of the present invention there is also provided a vehicle identification tag reader, comprising: a) a casing configured for attachment to a fuel-dispensing nozzle; b) an identification tag reading transceiver associated with the casing; c) a rechargeable power storage unit for supplying energy to the transceiver; and d) a generator to convert mechanical energy from movement of the tag-reader into electrical energy to recharge the power storage unit.

According to an aspect of some embodiments of the present invention there is also provided a vehicle identification tag reader that, in some embodiments, is exceptionally safe by including a recharging component for a power storage unit that works by induction. Thus, according to an aspect of some embodiments of the present invention there is also provided a vehicle identification tag reader, comprising: a) a casing configured for attachment to a fuel-dispensing nozzle; b) an identification tag reading transceiver associated with the casing; c) a rechargeable power storage unit for supplying energy to the transceiver; and d) a recharging component configured to provide electrical energy to recharge the power storage unit by induction.

In some embodiments, a vehicle identification tag reader of the present invention further comprises a station communication transceiver configured for two-way communication with a service station controller. In some embodiments, the identification tag reading transceiver is configured for two-way communication with a service station controller. In some embodiments, the vehicle identification tag reader is provided with a separate station communication transceiver. In some embodiments, the station communication transceiver has at least three modes: i) an active mode, wherein the station communication transceiver is operative to transmit signals and to receive transmissions from the service station controller; ii) a rest mode, wherein the station communication transceiver is operative to receive transmissions from the service station controller; and iii) a sleep mode, wherein the station communication transceiver substantially reduces energy usage. In some embodiments, the station communication transceiver is configured to enter the sleep mode after a predetermined period of inactivity and to periodically enter the rest mode from the sleep mode. In some embodiments, the station communication transceiver enters the active mode from the rest mode upon receipt of a transmission from a service station controller.

In some embodiments of a vehicle identification tag reader of the present invention, the identification tag reading transceiver has at least two modes: iv) an active mode, wherein the identification tag reading transceiver is operative to transmit signals and to receive return transmissions from an identification tag; and v) a sleep mode, wherein the identification tag reading transceiver substantially reduces energy usage. In some embodiments of the present invention, the identification tag reading transceiver enters the sleep mode after a predetermined period of inactivity. In some embodiments, of the present invention, a vehicle identification tag reader of the present invention comprises a use detector, configured to detect that a fuel-dispensing nozzle to which the vehicle identification tag reader is attached is to be used and subsequently sets the identification tag reading transceiver to the active state. In some embodiments, the use detector is a movement detector, configured to detect movement of a fuel-dispensing nozzle to which the vehicle identification tag reader is attached. In some embodiments, the station communication transceiver is configured to set the identification tag reading transceiver to the active mode upon receipt of instructions from the service station controller.

In some embodiments of a vehicle identification tag reader of the present invention, the configuration for attachment to a fuel-dispensing nozzle is reversible, allowing simple attachment, removal and reattachment, for example for replacement, for example in case of technical difficulties, hardware upgrading or when a power storage unit of a vehicle identification tag reader is no longer effective. In some embodiments of a vehicle identification tag reader of the present invention, the configuration for attachment to a fuel-dispensing nozzle comprises a clamping unit having at least two clamping components moveable relative one to the other. In some embodiments, the clamping unit is configured to clamp about the fuel-dispensing pipe of the fuel-dispensing nozzle. In some embodiments of a vehicle identification tag reader of the present invention, the configuration for attachment to a fuel-dispensing nozzle comprises a constricting band, configured to close about the fuel-dispensing pipe of the fuel-dispensing nozzle.

According to an aspect of some embodiments of the present invention there are also provided a method and a vehicle identification tag reader that, in some embodiments, are configured to be resistant to fuel theft by use of a variable range identification vehicle identification tag reader. Thus, according to an aspect of some embodiments of the present invention there is also provided a method of reducing fuel-theft, comprising: a) placing a fuel-dispensing nozzle provided with a vehicle identification tag reader including a variable transmission power transceiver in proximity of a refueling port of a vehicle provided with a passive vehicle identification tag; b) determining the identity of a vehicle with which the passive vehicle identification tag is associated; c) transmitting a signal to the passive vehicle identification tag from the vehicle identification tag reader with a power level determined at least in part on the identity of the vehicle with which the passive vehicle identification tag is associated.

In some embodiments, determining the identity of a vehicle with which the passive vehicle identification tag is associated includes receipt of a power-determining signal by the vehicle identification tag reader, in some embodiments from an active identification tag associated with the passive vehicle identification tag, in some embodiments from a service station controller, and in some embodiments from the passive identification tag. In some embodiments of the latter case, the vehicle identification tag reader transmits an exploratory signal having a sufficient power to read substantially any associated passive vehicle identification tag and in response the passive vehicle identification tag transmits the power-determining signal.

In some embodiments, the power-determining signal comprises the required power level. In some embodiments, the power-determining signal comprises a passive vehicle identification tag identity. In some embodiments, the power-determining signal comprises a vehicle model.

According to an aspect of some embodiments of the present invention there is also provided a vehicle identification tag reader, comprising: a) an identification tag reading transceiver functionally associated with a fuel-dispensing nozzle of a fuel-dispenser; and b) a transmission power controller configured to change the power level of transmission of the tag reading transceiver. In some embodiments, the vehicle identification tag reader comprises a logic circuit configured to determine a desired power level based on a vehicle identity: the vehicle identification tag reader receives a vehicle identity and determines what power level is required to reduce the chance of fuel theft in accordance with the teachings of the present invention. In some embodiments, a vehicle identification tag reader further comprises a station communication transceiver configured to receive a signal from a service station controller relating to a desired power level. In some embodiments, the identification tag reading transceiver is configured for two-way communication with a service station controller. In some embodiments, the vehicle identification tag reader is provided with a separate station communication transceiver.

According to an aspect of some embodiments of the present invention there is also provided a vehicle identification tag reader that comprises a single casing with which are associated an identification tag reading transceiver, an antenna of an identification tag reading transceiver, a station communication transceiver configured for two-way communication with a service station controller (which in some embodiments, shares components with or is the identification tag reading transceiver) and a power storage unit for supplying energy to the other components including the one or more transceivers.

According to an aspect of some embodiments of the present invention there is also provided a vehicle identification tag reader, comprising: a) a casing configured for attachment to a fuel-dispensing nozzle; b) an identification tag reading transceiver sealed within the casing; c) a power storage unit for supplying energy to the transceiver (and, in some embodiments, other components requiring power); and d) an identification tag reading antenna functionally associated with the identification tag reading transceiver.

In some embodiments, the identification tag reading antenna is a loop-shaped antenna. In some embodiments, the identification tag reading antenna is configured so that when the casing is attached to a fuel-dispensing nozzle, the identification tag reading antenna encircles at least part of the nozzle. In some embodiments, the identification tag reading antenna is associated with a loop-shaped portion of the casing, configured so that when the casing is attached to a fuel-dispensing nozzle, the identification tag reading antenna and the loop-shaped portion of the casing encircle at least part of a the nozzle. In some embodiments, the identification tag reading antenna is embedded within a loop-shaped portion of the casing, configured so that when the casing is attached to a fuel-dispensing nozzle, both the identification tag reading antenna and the loop-shaped portion of the casing encircle at least part of the nozzle. In some embodiments, the casing, including the loop-shaped portion of the casing, is monolithic. In some embodiments, the identification tag reading antenna is embedded within the loop-shaped portion of the casing.

### BRIEF DESCRIPTION OF THE FIGURES

Some embodiments of the invention are herein described, by way of example only, with reference to the accompanying figures. With specific reference now to the figures in detail, it is stressed that the particulars shown are by way of example and for purposes of illustrative discussion of some embodiments of the invention. In this regard, the description taken with the figures makes apparent to those skilled in the art how some embodiments of the invention may be practiced.

In the figures:

FIGS. 1A and 1B are schematic depictions of an identification vehicle identification tag reader including an identification tag reading transceiver sealed within a casing in accordance with an aspect of the present invention;

FIG. 1C is a schematic depiction of an identification vehicle identification tag reader including an identification tag reading transceiver sealed within a casing in accordance with an aspect of the present invention and a loop-shaped antenna functionally associated therewith;

FIG. 2 is a schematic depiction of an identification vehicle identification tag reader including a photovoltaic cell in accordance with an aspect of the present invention;

FIGS. 3A-3E are schematic depiction of an identification vehicle identification tag reader including a trigger operated generator in accordance with an aspect of the present invention;

FIG. 4 is a schematic depiction of an identification vehicle identification tag reader including a movement operated generator in accordance with an aspect of the present invention; and

FIG. 5 (prior art) is a schematic depiction of fuel theft made difficult by an aspect of the present invention.

### DESCRIPTION OF SPECIFIC EMBODIMENTS OF THE INVENTION

The present invention is of methods and devices, some embodiments of which are useful for implementing purchase authorization systems for purchases associated with a vehicle.

The principles, uses and implementations of the teachings of the present invention may be better understood with reference to the accompanying description and figures. Upon perusal of the description and figures present herein, one skilled in the art is able to implement the teachings of the present invention without undue effort or experimentation.

Before explaining at least one some embodiment of the invention in detail, it is to be understood that the invention is not limited in its application to the details set forth herein. The invention can be implemented with other some embodiments and can be practiced or carried out in various ways. It is also understood that the phraseology and terminology employed herein is for descriptive purpose and should not be regarded as limiting.

Generally, the nomenclature used herein and the laboratory procedures utilized in the present invention include techniques from the fields of computer science, commerce, communications, material sciences and engineering. Such techniques are thoroughly explained in the literature. Unless otherwise defined, all technical and scientific terms used herein have the same meaning as commonly understood by one of ordinary skill in the art to which the invention belongs. In addition, the descriptions, materials, methods and examples are illustrative only and not intended to be limiting. Methods and materials similar or equivalent to those described herein can be used in the practice or testing of the present invention. All publications, patent applications, patents and other references mentioned are incorporated by reference in their entirety as if fully set forth herein. In case of conflict, the terms are to be understood as used in the specification.

As used herein, the terms “comprising” and “including” or grammatical variants thereof are to be taken as specifying the stated features, integers, steps or components but do not preclude the addition of one or more additional features, integers, steps, components or groups thereof. These terms encompass the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The term “method” refers to manners, means, techniques and procedures for accomplishing a given task including, but not limited to, those manners, means, techniques and procedures either known to, or readily developed from known manners, means, techniques and procedures by practitioners of the relevant arts. Implementation of the methods of the present invention involves performing or completing selected tasks or steps manually, automatically, or a combination thereof.

Herein, the term “passive device” refers to a device that stores data (whether read-only or rewritable) that does not have an own power source. The term encompasses data storage devices that receive an amount of power from a reader by induction and then use the received power to transmit the data, such as RFID tags and circuits.

Herein, the term “active device” refers to a device associated with a power source that stores data (whether read-only or rewritable) where the device is configured to transmit the data using power from the associated power source.

Herein, the term “fuel dispenser” refers to a device that dispenses fuel, for example to a vehicle, and generally includes a pump, at least one hose and at least one fuel-dispensing nozzle with a fuel dispensing actuator such as a trigger.

Service stations are rarely constructed a priori for electronic payment and vehicle identification. Rather, a service station generally includes a mechanical fuel-dispensing nozzle. When it is desired to upgrade a service station with the installation of an electronic payment system based on reading a vehicle identification tag, such as a vehicle identification tag attached in proximity of the vehicle refueling port, it is usually necessary to retrofit a vehicle identification tag reader to each fuel-dispensing nozzle with a dedicated power source. One approach is to run a power and communication cable from the service station controller underground to each fuel-dispensing pump in channels that exist for the standard fuel dispensing control system. The power and communication cable is then run in parallel to a fuel-dispensing hose to connect to an identification vehicle identification tag reader attached to the fuel-dispensing nozzle. The installation of such identification vehicle identification tag readers is very expensive and difficult to retrofit. Such systems also constitute a safety hazard due to the proximity of a long and vulnerable power cable to a fuel-dispensing hose filled with highly flammable gasoline. An alternative is an electricity generator powered by fuel flowing through the fuel-dispensing hose as taught in U.S. Pat. No. 6,648,032. A disadvantage of such an electricity generator is that at least one additional fuel resistant seal is required in the fuel-dispensing nozzle, increasing the chance of fuel leakage. Since there are many different models of fuel-dispensing nozzles, it is necessary to provide at least one model of the electricity generator for each fuel-dispensing nozzle model, increasing installation, maintenance and logistical costs. Further, to transfer generated electricity from the generator to an identification vehicle identification tag reader requires a wire running on the outside of the fuel-dispensing nozzle, constituting a safety hazard and increasing the costs of installation.

Fuel-dispensing nozzles are exposed to extreme conditions: located outside in extreme cold, heat, subject to dust and wind and exposed not only to humidity but also to gasoline. The identification vehicle identification tag readers known in the art are provided with openings into the vehicle identification tag reader casing for the required power and communication cables. Such openings constitute a vulnerable point to the elements. Further, such openings may provide access to the electronics of the identification vehicle identification tag reader allowing illicit use.

As noted above, an aspect of the present invention is of a vehicle identification tag reader that is simple to install or retrofit and is exceptionally safe and durable due to the fact that components are sealed within a casing.

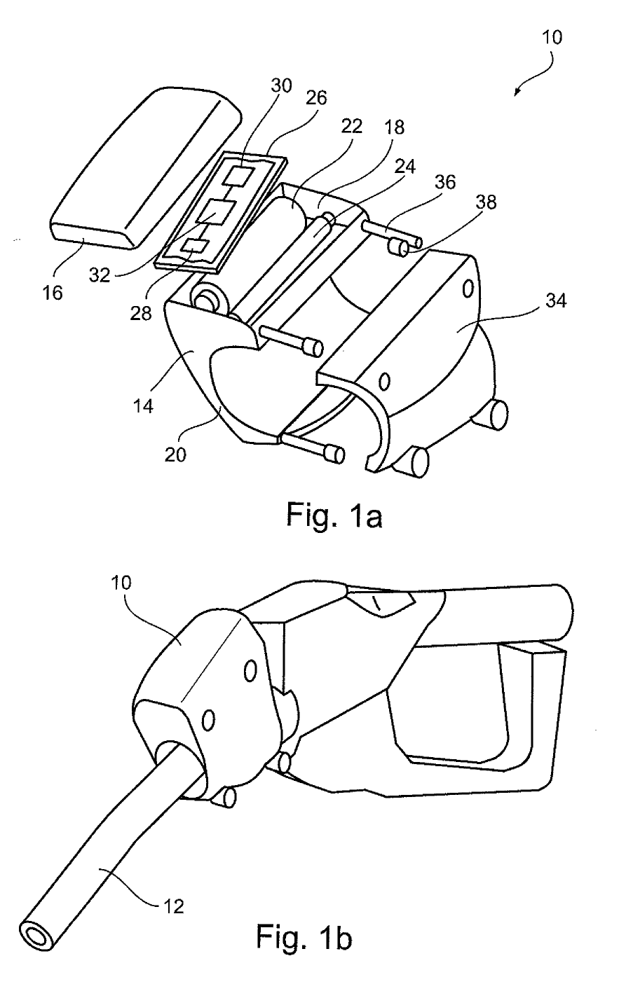

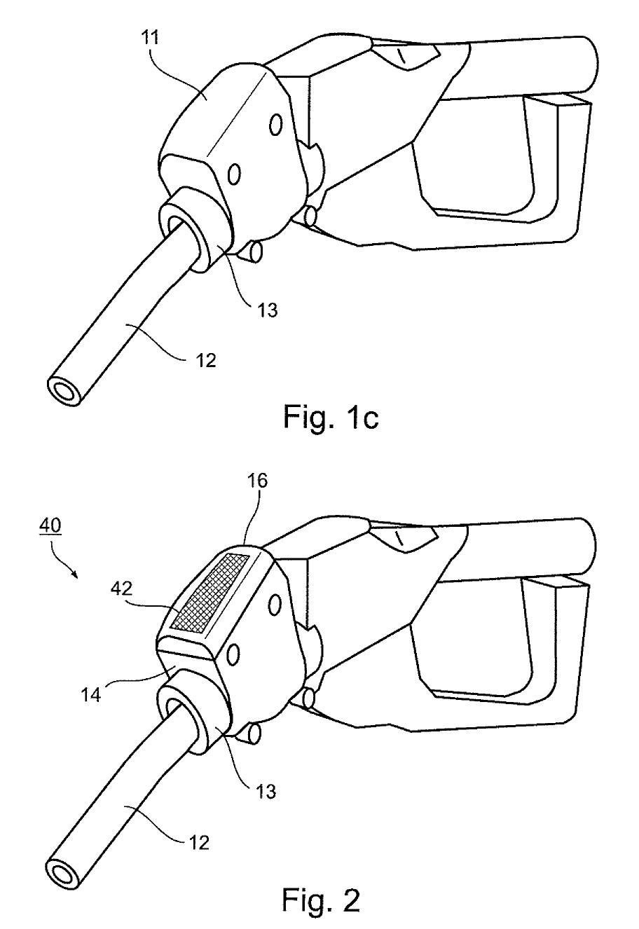

An exemplary embodiment of an aspect of the present invention, identification vehicle identification tag reader 10 is depicted in FIGS. 1A (exploded) and 1B (assembled) attached to a fuel-dispensing nozzle 12.

In FIG. 1A components of identification vehicle identification tag reader 10 are shown including a lower casing part 14 and an upper casing part 16. Lower casing part 14 is a monolithic component of molded fiber-reinforced polymer (e.g., Nylon) and includes an open chamber 18 and a clamping jaw 20. Upper casing part 16 is configured to fit to upper casing part 16, closing open chamber 18. Configured to fit inside chamber 18 are power storage unit 22 (a rechargeable battery), a recharging unit including an induction coil 24, and a populated circuit board 26 including an identification tag reading transceiver 28, a station communication transceiver 30 and a control processor 32. Opposing clamping jaw 34 is attachable to lower casing part 14 with the help of four bolts 36 and four nuts 38.

Manufacture of the components of identification vehicle identification tag reader 10 is well within the ability of one skilled in the art without undue experimentation upon perusal of the description herein. Assembly of identification vehicle identification tag reader 10 is straightforward and substantially as depicted in FIG. 1A, including placing power storage unit 22, induction coil 24 and populated circuit board 26 inside chamber 18. Once the components are placed inside chamber 18, upper casing part 16 is properly placed and secured to lower casing part 14 so as to seal chamber 18, using methods known in the art such as the use of adhesives, welding or soldering. In some embodiments, casing parts 14 and 16 of fiber reinforced polymers are attached by ultrasonic welding to provide a seamless monolithic casing having a sealed chamber having no openings that contains power storage unit 22, induction coil 24 and populated circuit board 26.

In identification vehicle identification tag reader 10, identification tag reading transceiver 28 and other components are enclosed within a sealed chamber 18 inside the casing made of casing parts 14 and 16. In some embodiments, an identification tag transceiver such as 28 and other components are embedded within a casing for example during a molding or other production process.

As depicted in FIG. 1B, for installation clamping jaw 20 and opposing clamping jaw 34 are placed around a fuel-dispensing nozzle 12 and clampingly secured with the use of nuts 38 and bolts 36. As attachment and detachment of identification vehicle identification tag reader 10 requires simple clamping about a fuel-dispensing nozzle 12 and requires neither disassembly of any component thereof nor attachment and securing of any cables or wires, installation is simple and can be performed by a person with no special training or education. Further, the simplicity and ease of assembly and disassembly allows the identification vehicle identification tag reader to be replaced at low cost, whether for a periodic hardware upgrade or as a result of malfunction.

A disadvantage of a relatively small antenna associated with and located near an identification tag transceiver, such as identification tag transceiver 28 of identification vehicle identification tag reader 10 depicted in FIGS. 1A and 1B where an antenna is held within casing 14, for example on printed circuit board 26, is that in some cases the quality of radio communication between a vehicle identification tag being read and the identification tag reading transceiver is dependent on the orientation of the nozzle (on which the identification tag reading transceiver is mounted as depicted in FIG. 1B) relative to the vehicle fuel inlet (near which the vehicle identification tag is mounted). To overcome such disadvantages, in some embodiments of the present invention an identification tag reading antenna is loop-shaped.

In FIG. 1C is depicted an identification-vehicle identification tag reader 11 similar to the identification-vehicle identification tag reader depicted in FIGS. 1A and 1B except that identification-vehicle identification tag reader 11 includes a loop-shaped antenna embedded inside a loop-shaped part 13 of the casing of vehicle identification tag reader 11, the loop-shaped antenna functionally associated with an identification-tag reading transceiver encased within the casing. As is seen in FIG. 1C, the antenna and loop-shaped part of the casing 13 is configured so that when the casing is attached to a fuel-dispensing nozzle 12, the antenna and the loop-shaped part of the casing 13 encircles at least part of the nozzle. In such a way, the loop-shaped antenna allows effective reading of an identification tag positioned near the fuel inlet of a vehicle with little regards as to the angle in which nozzle 12 engages a vehicle fuel inlet.

In identification-vehicle identification tag reader 11, the loop-shaped antenna is embedded inside loop-shaped part 13 of the casing, loop-shaped part 13 being an integral part of the rest of the casing so that the casing is monolithic. In some embodiments, the antenna and associated casing constitute a loop-shaped component separate from the casing. In some embodiments, the loop-shaped component is secured, e.g., by adhesive or welding to the casing. In some embodiments, the loop-shaped component is reversibly attachable to the casing, for example, by plugging leads of the antenna into sockets in the casing.

Use of identification vehicle identification tag reader 10 or 11 attached to fuel-dispensing nozzle 12 is simple and analogous to the use of prior art identification vehicle identification tag readers or to the use of vehicle identification tag readers as described in the PCT Patent Applications published as WO2007/049273 and WO2007/049274 of the Applicant. In a simple embodiment, fuel-dispensing nozzle 12 is placed inside the refueling port of a vehicle provided with an identification tag (such as an RFID tag) so that vehicle identification tag reader 10 or 11 is within read range of the identification tag. It is important to note that in this respect vehicle identification tag reader 11 is superior to vehicle identification tag reader 10. When vehicle identification tag reader 10 is placed in the refueling port, it may be oriented so as to be far away from the identification tag and not be in range to read the identification tag. However, vehicle identification tag reader 11 does not suffer this problem as the antenna is looped shaped and surrounds fuel-dispensing nozzle 12. Identification tag transceiver 28 is activated to read the identification tag and transmits signals to the identification tag. The identification tag receives power from the transmitted signal and then retransmits, for example, an identification tag identifier. Identification tag transceiver 28 receives and forwards the identification tag identifier to control processor 32 that forwards the identification tag identifier, using station communication transceiver 30 to a service station controller. Based on various data and policies including the identification tag identifier, a service station controller transmits a refueling authorization to the fuel pump associated with fuel-dispensing nozzle 12 and fuel is dispensed to the vehicle in the usual way.

Although identification vehicle identification tag readers 10 or 11 depicted in FIGS. 1A, 1B and 1C are configured for attachment to a fuel-dispensing nozzle 12 with the use of clamping components, other configurations of attachment are also found within the scope of the invention. For example, in some non-depicted embodiments an identification vehicle identification tag reader is configured to be attached to a fuel-dispensing nozzle using a constriction component, e.g., a component resembling a prior art flexible tie. For example, in some embodiments, a casing is provided with integrally formed loops through which prior art plastic ties are threaded and the plastic ties are then looped and constricted about a fuel-dispensing nozzle.

Although identification vehicle identification tag readers 10 or 11 depicted in FIGS. 1A, 1B and 1C are provided with two separate transceivers, identification tag reading transceiver 28 for reading a vehicle identification tag and station communication transceiver 30 for communicating with a service station controller, in some embodiments an identification vehicle identification tag reader is provided with a single transceiver that is configured both for reading an identification tag and for communicating with a service station controller.

As noted above, identification vehicle identification tag readers 10 and 11 depicted in FIGS. 1A, 1B and 1C are not provided with a continuous supply of power but rather use energy stored in power storage unit 22. In some embodiments, an identification vehicle identification tag reader of the present invention is configured (for example, using an appropriately configured control processor) to issue a warning, for example using a station communication transceiver, of low power in power storage unit 22. In some embodiments, an identification vehicle identification tag reader of the present invention is disposable, that is to say, once power storage unit 22 is empty the identification vehicle identification tag reader is replaced. In contrast, identification vehicle identification tag readers 10 and 11 depicted in FIGS. 1A, 1B and 1C are provided with a recharging unit including an induction coil 24 in accordance with an aspect of the present invention. Periodically, or when power storage unit 22 is low on power, a recharging professional recharges power storage unit 22 with the help of induction coil 24.

In some embodiments of the present invention, such as identification vehicle identification tag readers 10 or 11, an identification vehicle identification tag reader is configured to operate with as little energy as possible to reduce costs associated with charging or replacing an identification vehicle identification tag reader.

For saving energy, in some embodiments, a station communication transceiver such as 30 has at least three modes. A first mode is an active mode, wherein the station communication transceiver is operative to transmit signals and to receive transmissions from the service station controller. The first mode is the mode used, for example, during the actual reading of an identification tag and receiving of refueling authorization. A second mode is a rest mode, wherein the station communication transceiver is operative to receive transmissions from the service station controller but does not transmit. A third mode is a sleep (energy-saving) mode wherein the station communication transceiver substantially reduces energy usage to a minimum, as is known in the art. For example, in some embodiments, a station communication transceiver enters a sleep mode after a predetermined period of inactivity or upon receipt of a command from a service station controller. In some embodiments, a station communication transceiver enters the rest mode from the sleep mode upon detection of use, e.g., when the identification vehicle identification tag reader is moved for use. In some embodiments, a station communication transceiver enters the rest mode from the sleep mode periodically according to a predetermined schedule. In some embodiments, a station communication transceiver enters the active mode from the rest mode upon receipt of a transmission from a service station controller.

For saving energy, in some embodiments, an identification tag reading transceiver such as 28 has at least two modes. A first mode is an active mode, wherein the identification tag reading transceiver is operative to transmit signals and to receive return transmissions from an identification tag. The first mode is the mode used, for example, during the actual reading of a vehicle identification tag and receiving of refueling authorization. A second mode is a sleep (energy-saving) mode, wherein the identification tag reading transceiver substantially reduces energy usage to a minimum, as is known in the art. For example, in some embodiments an identification tag reading transceiver enters a sleep mode after a predetermined period of inactivity (e.g., after refueling authorization has been received or after the refueling process has finished) or upon receipt of a command from a service station controller. In some embodiments, an identification tag reading transceiver enters the rest mode from the sleep mode upon detection of use, e.g., when the identification vehicle identification tag reader is moved for use. In some embodiments, an identification tag reading transceiver enters the active mode from the rest mode upon receipt of a transmission from a service station controller, for example via a control processor such as 32 and a station communication transceiver such as 30.

In order to assist in determining if an identification vehicle identification tag reader is being used, for example for activating an identification tag reading transceiver or a station communication transceiver as described above, in some embodiments an identification vehicle identification tag reader of the present invention includes a use detector, configured to detect that a fuel-dispensing nozzle to which the identification vehicle identification tag reader is attached is to be used. In some embodiments, the use detector is a movement detector configured to detect movement of a fuel-dispensing nozzle to which the vehicle identification tag reader is attached. For example, in some embodiments a vehicle identification tag reader includes a liquid mercury switch. When a fuel-dispensing nozzle to which a vehicle identification tag reader is attached is held in a cradle and not moved, the switch is closed. When the fuel-dispensing nozzle is removed from the cradle for dispensing fuel, the liquid mercury sloshes inside the switch, closing the circuit and indicating that the vehicle identification tag reader and consequently the fuel-dispensing nozzle has been moved.

As noted above, an aspect of the present invention is of a vehicle identification tag reader that includes one or more photovoltaic cells to provide power for an associated tag reading transceiver. An exemplary embodiment of this aspect of the present invention, identification vehicle identification tag reader 40 is depicted in FIG. 2 attached to a fuel-dispensing nozzle 12. Identification vehicle identification tag reader 40 is substantially similar to identification vehicle identification tag reader 11 discussed above but is devoid of an induction coil 24 and is instead provided with a photovoltaic cell 42 configured to convert light to electrical energy to recharge a respective power storage unit 22. Photovoltaic cell 42 of identification vehicle identification tag reader 40 is embedded inside transparent upper casing part 16 which is secured to lower casing part 14 so that the casing is monolithic and seamless: in identification vehicle identification tag reader 40 upper casing part 16 is fashioned from nylon not reinforced by glass fibers in order to increase the transparency of upper casing part 16 to the wavelength of light required by photovoltaic cell 42.

The manufacture, assembly and use of identification vehicle identification tag reader 40 are substantially similar to the manufacture, assembly and use of identification vehicle identification tag reader 10 as described above.

Although photovoltaic cell 42 of identification vehicle identification tag reader 40 is sealed within upper casing part 16, in some embodiments photovoltaic cell is otherwise associated with an identification vehicle identification tag reader.

Although identification vehicle identification tag reader 40 incorporates an aspect of the present invention by having an identification tag reading transceiver as well as other components enclosed within a sealed chamber, in some embodiments the identification tag reading transceiver is associated with the casing without being enclosed within.

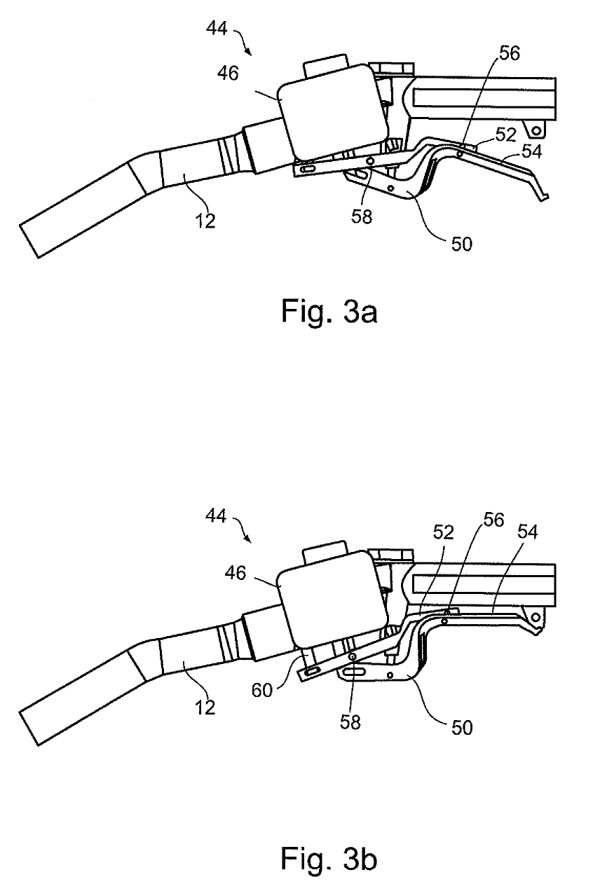

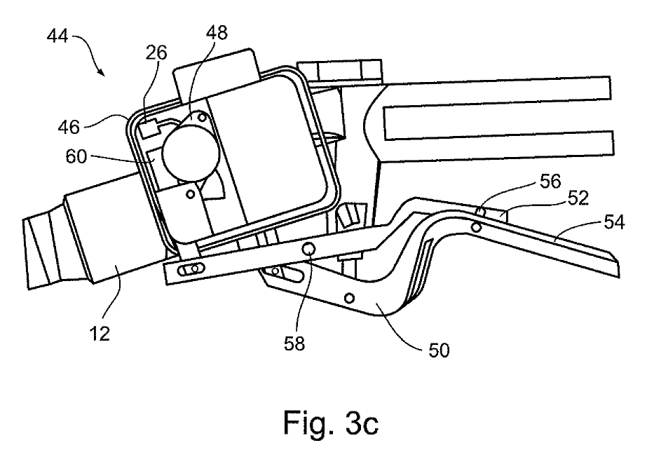

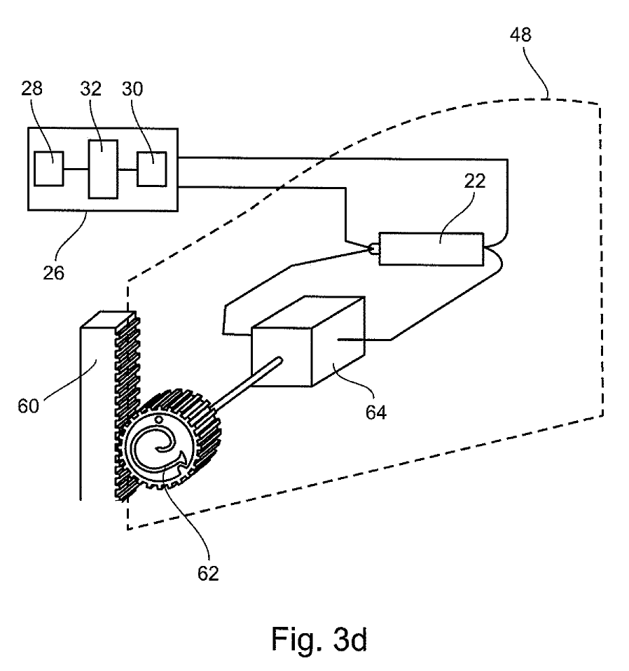

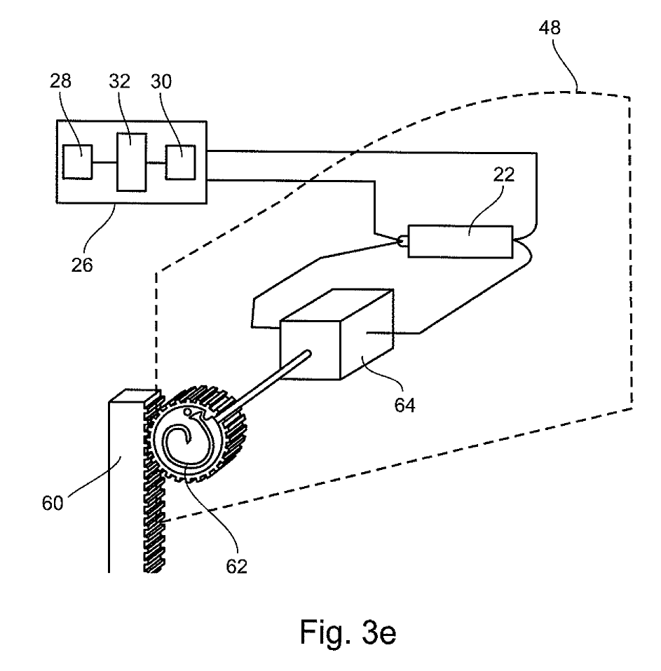

As noted above, an aspect of the present invention is of a vehicle identification tag reader that includes a trigger powered electricity generator to provide power for the associated tag reading transceiver. An exemplary embodiment of this aspect of the present invention, identification vehicle identification tag reader 44 attached to a fuel-dispensing nozzle 12 is depicted in FIGS. 3A-3E. Identification vehicle identification tag reader 44 is substantially similar to identification vehicle identification tag reader 10 and 11 discussed above in that within casing 46 (as depicted in FIG. 3C) are contained components such as a power storage unit 22, and a populated circuit board 26 including an identification vehicle identification tag reader 28, a station communication transceiver 30 and a control processor 32.

Unlike identification vehicle identification tag readers 10 and 11 depicted in FIGS. 1A, 1B and 1C where power storage unit 22 is configured to supply electrical power, power storage unit 22 of identification vehicle identification tag reader 44 is a component of power generation unit 48 that also includes a coil spring 62 and an electricity generator 64 that is activated by the compression of trigger 50 of fuel-dispensing nozzle 12.

For installation, identification vehicle identification tag reader 44 is secured to fuel-dispensing nozzle 12 in any suitable way, for example with clamping components or constricting components (not depicted). During installation, charging arm 52 is placed in sliding contact with upper surface 54 of trigger 50, for example with the help of plastic tie 56.

Use of identification vehicle identification tag reader 44 attached to fuel-dispensing nozzle 12 is substantially as described above. Fuel-dispensing nozzle 12 is placed inside the refueling port of a vehicle provided with an identification tag (such as an RFID tag) so that identification vehicle identification tag reader 44 is within read range of the identification tag. Identification tag transceiver 28 is activated to read the identification tag and transmits signals to the identification tag. The identification tag receives power from the transmitted signal and then retransmits, for example, an identification tag identifier. Identification tag transceiver 28 receives and forwards the identification tag identifier to control processor 32 that forwards the identification tag identifier, using station communication transceiver 30 to a service station controller. Based on various data and policies including the identification tag identifier, the service station controller transmits a refueling authorization to the fuel pump associated with fuel-dispensing nozzle 12 and fuel is dispensed to the vehicle in the usual way.

In some embodiments, the reading of an identification tag as described above begins and continues with the use of power stored in power storage unit 22 of power generation unit 48. When trigger 50 is pulled upwards (from a state as depicted in FIGS. 3A, 3C and 3D to a state depicted in FIGS. 3B and 3E) to dispense fuel from fuel-dispensing nozzle 12, charging arm 52 is pushed upwards and pivots around axis 58, pulling piston 60 which winds coil spring 62 coupled to electricity generator 64. When trigger 50 reaches an uppermost location, coil spring 62 unwinds, driving electricity generator 64. Power from electricity generator 64 recharges power storage unit 22.

In some embodiments, the reading of an identification tag as described above is initiated only subsequent to pulling of trigger 50. In some embodiments, reading initiation subsequent to pulling trigger 50 is in order to use energy generated by electricity generator 64 for powering identification tag reading transceiver 28. In some embodiments of such some embodiments, an identification vehicle identification tag reader is devoid of a power storage unit 22 and runs only on trigger-generated power.

In some embodiments, the generation of power by electricity generator 64 initiated by pulling of trigger 50 is utilized as a use-detector for changing a mode in which an identification tag reading transceiver or a station communication transceiver (e.g., 28) is found, as described above.

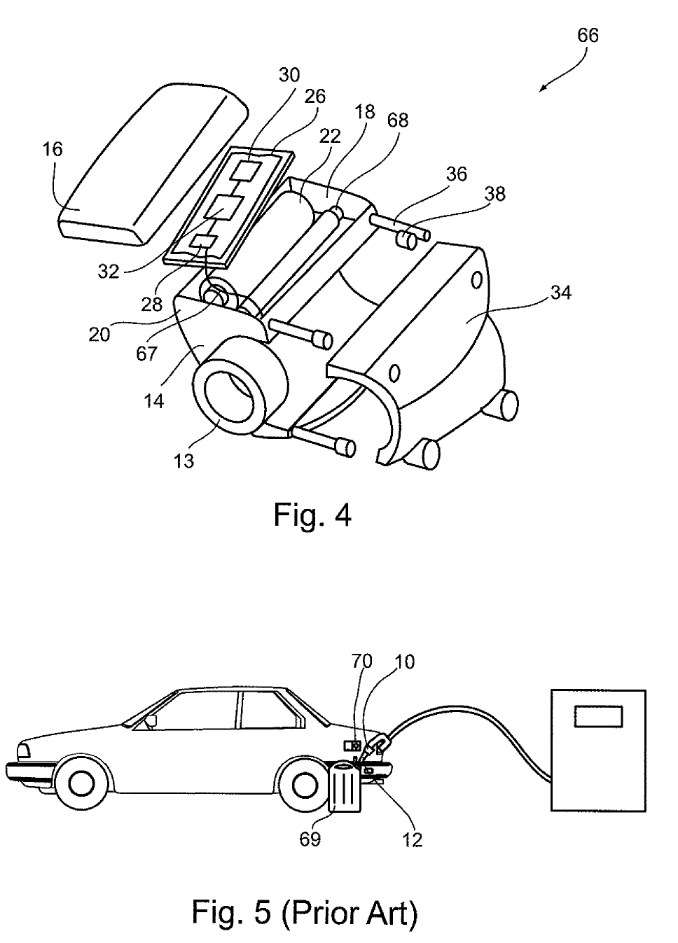

As noted above, an aspect of the present invention is of a vehicle identification tag reader that includes a generator to convert mechanical energy from movement of the tag-reader into electrical energy to recharge the power storage unit, analogously to the kinetic power generators known in the art of portable timepieces. An exemplary some embodiment of this aspect of the present invention, identification vehicle identification tag reader 64 is depicted exploded in FIG. 4. Identification vehicle identification tag reader 66 is substantially similar to identification vehicle identification tag reader 10 discussed above in that within a casing comprising casing parts 14 and 16 are contained components such as a power storage unit 22, and a populated circuit board 26 including an identification vehicle identification tag reader 28, a station communication transceiver 30 and a control processor 32. Identification vehicle identification tag reader 28 is functionally associated with a loop-shaped antenna held inside a loop-shaped part 13 of casing 14 of vehicle identification tag reader 66 through wire 67. Unlike identification vehicle identification tag readers 10 and 11 depicted in FIGS. 1A, 1B and 1C including an induction coil 24 for recharging power storage unit 22, identification vehicle identification tag reader 66 includes kinetic power generation unit 68, similar to the described in U.S. Pat. No. 6,154,422. In the art it is known that motion (such as shaking, moving or jostling) of an object with which a kinetic power generation unit 68 is associated activates the mechanism therein to generate electricity.

Manufacture, assembly and attachment of an identification vehicle identification tag reader 66 to a fuel-dispensing nozzle 12 is similar to the described above and is clear to one skilled in the art upon perusal of the description herein.

Use of an identification vehicle identification tag reader 66 is substantially identical to the use of an identification vehicle identification tag reader 44 with a significant exception that power is generated with the motion of a fuel-dispensing nozzle to which the identification vehicle identification tag reader is attached and not only subsequent to pulling of the respective trigger.

An advantage of an identification vehicle identification tag reader such as 44 or 66 is that these include an integrated power generator that is activated by movement of the respective fuel-dispensing nozzle 12 prior to the actual need of energy by a respective identification tag reading transceiver 28.

In the art, a known type of fuel theft from a service station provided with a fuel dispensing authorization system based on using passive vehicle identifications tags is that subsequent to receipt of authorization, fuel is dispensed into an alternate vessel (e.g., a jerrycan 69 or a soft-drink bottle) as depicted in FIG. 5 and not into a vehicular fuel tank. Such theft is based on placing a fuel-dispensing nozzle 12 in proximity of a refueling port 70 so that an identification vehicle identification tag reader 10 reads an identification tag while fuel-dispensing nozzle 12 is not inside refueling port 70 but close enough that identification vehicle identification tag reader 10 reads the identification tag in refueling port 70. As noted above, an aspect of the present invention is of a method and vehicle identification tag reader that are resistant to fuel theft, such as the fuel theft described above, by use of a variable range identification vehicle identification tag reader. Suitable variable range identification vehicle identification tag readers are Picoread™ from Contactless, Aix-en-Provence, France.

This aspect of the present invention is potentially implemented with most prior art vehicle identification tag readers and also with vehicle identification tag readers of the present invention. The aspect of the present invention is currently believed to be most effective using an identification vehicle identification tag reader where the identification tag reading transceiver is secured to a fuel-dispensing nozzle so as to be positioned as close as possible to the expected location of a vehicle identification tag as embodied, for example, in identification vehicle identification tag readers 10, 11, 40 and 66 discussed above. Implementing this aspect of the present invention generally involves modifying an identification tag reading transceiver and/or a control processor of an identification vehicle identification tag reader to include or be functionally associated with a transmission power controller configured to change the power level of transmission of the tag reading transceiver. Such transmission power controllers are commercially available and are well known to one skilled in the art.

As depicted in the Figures, some embodiments of a vehicle identification tag reader are convenient for installation, use and replacement as these include one casing, with which an identification tag reading transceiver (and, although not separately depicted, an associated antenna of an identification tag reading transceiver), a station communication transceiver configured for two-way communication with a service station controller (which in some embodiments, shares components with or is the identification tag reading transceiver) and a power storage unit for supplying energy to the other components including the one or more transceivers.

According to an aspect of the present invention, a fuel-dispensing nozzle provided with an identification vehicle identification tag reader is placed in proximity of a refueling port of vehicle provided with a passive vehicle identification tag. As part of the fuel dispensing authorization process, the identity of the vehicle with which the passive vehicle identification tag is associated is determined.

The identification tag reading transceiver transmits a read signal in the usual way, where the power level of the transmitted read signal is determined to be substantially as low as possible to ensure that a response is received from the passive vehicle identification tag only if the fuel-dispensing nozzle is properly placed inside the vehicle refueling port. Determining the required signal strength is based, in part on the identity of the vehicle.

In some embodiments, by identity of the vehicle is meant a given class of vehicles to which the vehicle belongs that determines the required signal power. In some embodiments of the present invention, by identity of the vehicle is meant the model of the vehicle as generally a passive identification tag will be positioned in all vehicles of the same model in substantially the same location and thus vehicle model will determine in large part the required signal power. In some embodiments of the present invention, by identity of the vehicle is meant the actual identity of the vehicle and the authorization system includes a method, such as a look-up table, to determine the required signal power for each individual vehicle.

If the fuel-dispensing nozzle is properly in place, then the distance between the identification tag reading transceiver and the identification tag is such that the power level determined is sufficient to allow the passive vehicle identification tag to transmit a response. The response is registered by the identification tag transceiver, relayed to the service station controller and refueling is authorized.

If the fuel-dispensing nozzle is not properly in place, then the distance between the identification tag reading transceiver and the identification tag is such that the power level determined is too weak to allow the passive vehicle identification tag to transmit a response. The lack of response is registered by the identification tag transceiver, relayed to the service station controller and refueling is not authorized.

In some embodiments, transmission at the determined power level and registration of a response as described above is performed throughout the refueling process to ensure that once refueling authorization is received, the fuel-dispensing nozzle is not removed from the refueling port while fuel is being pumped out through the fuel-dispensing nozzle.

Depending on the exact implementation and some embodiment, the signal related to the required power is received by the identification vehicle identification tag reader from one or more of various sources.

In some embodiments, a vehicle is provided with an active identification tag (as described in unpublished pending U.S. Patent Application No. 60/762,498 of the applicant) from which the identification vehicle identification tag reader receives the signal related to the required power.

In some embodiments, the identification vehicle identification tag reader receives the signal related to the required power from a service station controller. In such some embodiments the identification vehicle identification tag reader generally include a station communication transceiver for receipt of the signal from the service station controller.

In some embodiments, the identification vehicle identification tag reader receives the signal related to the required power from the passive identification tag. In such some embodiments for example, the vehicle identification tag reader transmits an exploratory signal having a sufficient power to read substantially any passive vehicle identification tag and in response the passive vehicle identification tag transmits the signal related to the required power power-determining signal.

In some embodiments, the power-determining signal received comprises the required power level.

In some embodiments, the power-determining signal received comprises the vehicle model or vehicle identity. In such some embodiments, an identification vehicle identification tag reader generally includes a logic circuit (in some embodiments a modification of or addition to control processor 32 or identification tag transceiver 28, but in some embodiments, for example, a separate component) configured to determine a required power level based on the power-determining signal received, for example a vehicle model or a vehicle identity. The signal is received and the logic circuit calculates, for example using a look-up table, what is the required power level.

It is appreciated that certain features of the invention, which are, for clarity, described in the context of separate some embodiments, may also be provided in combination in a single some embodiment. Conversely, various features of the invention, which are, for brevity, described in the context of a single some embodiment, may also be provided separately or in any suitable subcombination.

Methods and processes have been described herein as a series of steps in an order selected as being the easiest to understand. It must be emphasized that such order is not limiting, and any method or process may be performed in any reasonable order to achieve the desired result.

Although the invention has been described in conjunction with specific some embodiments thereof, it is evident that many alternatives, modifications and variations will be apparent to those skilled in the art. Accordingly, the present invention is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A vehicle identification tag reader, comprising:
a) a casing configured for attachment to a fuel-dispensing nozzle;
b) an identification tag reading transceiver sealed within said casing;
c) a power storage unit for supplying energy to said identification tag reading transceiver; and
d) an identification tag reading antenna functionally associated with said identification tag reading transceiver.

2. The vehicle identification tag reader of claim 1 wherein said identification tag reading antenna is a loop-shaped antenna.

3. The vehicle identification tag reader of claim 2, wherein said identification tag reading antenna is configured so that when said casing is attached to a fuel-dispensing nozzle, said identification tag reading antenna encircles at least part of a said fuel-dispensing nozzle.

4. The vehicle identification tag reader of claim 2, wherein said identification tag reading antenna is associated with a loop-shaped portion of said casing, configured so that when said casing is attached to a fuel-dispensing nozzle, said identification tag reading antenna and said loop-shaped portion of said casing encircle at least part of a said fuel-dispensing nozzle.

5. The vehicle identification tag reader of claim 3, wherein said identification tag reading antenna is embedded within a loop-shaped portion of said casing, configured so that when said casing is attached to a fuel-dispensing nozzle, said identification tag reading antenna and said loop-shaped portion of said casing encircle at least part of a said fuel-dispensing nozzle.

6. The vehicle identification tag reader of claim 4, wherein said casing including said loop-shaped portion of said casing, is monolithic.

7. The vehicle identification tag reader of claim 4, wherein said identification tag reading antenna is embedded within said loop-shaped portion of said casing.

8. The vehicle identification tag reader of claim 1, wherein said power storage unit is sealed within said casing.

9. The vehicle identification tag reader of claim 1, wherein said power storage unit is rechargeable.

10. The vehicle identification tag reader of claim 1, further comprising a station communication transceiver configured for two-way communication with a service station controller.

11. The vehicle identification tag reader of claim 1, wherein said configuration for attachment to a fuel-dispensing nozzle comprises a clamping unit having at least two clamping components moveable relative one to the other.

12. The vehicle identification tag reader of claim 1, wherein said configuration for attachment to a fuel-dispensing nozzle comprises a constricting band.
